(19) United States
(12) Patent Application Publication
(10) Pub. No.: US 2006/0106988 A1
(43) Pub. Date: May 18, 2006

(54) Method and system for exchanging data

(76) Inventors: Charbel Khawand, Miami, FL (US); Arthur M. Goldberg, Parkland, FL (US); Jianping Tao, Cedar Park, TX (US); John J. Vaglica, Austin, TX (US); Chin P. Wong, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/990,133

(22) Filed: Nov. 16, 2004

(51) Int. Cl. G06F 12/00

(52) U.S. Cl. 711/130

(57) ABSTRACT

The invention concerns a method (300) and system (100) for exchanging data in a multi-core architecture having at least one shared memory (114). The method can include the steps of requesting (312) data in a first format from a predetermined range of addresses in the shared memory in which the data is shared between different processors, storing (316) the requested data in a cache (118) to be retrieved by a format converter (120) and identifying (320) to the format converter a data type for the data. The method can also include the step of, with the format converter, translating (322) based on predetermined rules the data to a second format that is native to a processor (110) that will process the data.

### BACKGROUND OF THE INVENTION

1. Field of the Invention

This invention relates in general to the exchange of data and more particularly to the exchange of data between multiple processing cores that share a common memory.

2. Description of the Related Art

Current platform architectures combine multiple processing cores, such as a digital signal processing (DSP) core and a host application processing (AP) core. These two cores share data from a common memory, which mandates that they both operate on data in their native mode of operation. For example, the DSP core may require a big endian memory model, and the AP core may operate on little endian organization. The sharing of data in view of these different memory models, however, is complicated by the manner in which data is loaded in each model.

To overcome the incompatibility, several methods have been proposed that convert data between the big endian and little endian memory models. Up to this point, however, the conversion has been limited to the big endian/little endian memory models, with a focus on software. This approach ignores the possibility of different memory organizations and imposes limitations on the software used to operate on the shared data.

### SUMMARY OF THE INVENTION

The present invention concerns a method for exchanging data. The method can include the steps of—in a multi-core architecture having at least one shared memory—requesting data in a first format from a predetermined range of addresses in the shared memory in which the data is shared between different processors and storing the requested data in a cache to be retrieved by a format converter. The method can also include the steps of identifying to the format converter a data type for the data and—with the format converter—retrieving the data from the cache and translating—based on predetermined rules—the data to a second format that is native to a processor that will process the data. As an example, the predetermined rules can be programmable in the format converter.

The method can also include the step of automatically enabling the format converter when the data is requested from the predetermined range of addresses in the shared memory. In addition, when the format converter is enabled, the method can include the steps of dedicating the cache to storing the data and isolating other instruction and data caches from the shared memory. In one arrangement, the size of the format converter can be variable, and the method can further include the step of setting a data boundary size in the format converter. The data boundary size can be based on a bus size, for example. The method can also include the step of bypassing the format converter when it is unnecessary to translate the data from the first format to the second format.

In another arrangement, the first format can be based on a little endian memory model, a big endian memory model or an emulated big endian model, and the second format can be based on a translated little endian memory model, a translated big endian memory model or a translated emulated big endian memory model. The method can also include the step of retranslating the data from the second format to the first format. As another example, the data type can be at least one of a byte, a word and a double word. In another embodiment of the invention, the multi-core architecture can include a plurality of shared memories. The method can include the steps of programming into the format converter predetermined rules for each shared memory and selecting the predetermined rules based on the type of shared memory that the format converter accesses.

The present invention also concerns a system for exchanging data. The system can include a first processor, a second processor, at least one memory coupled to both the first processor and the second processor in which the first processor and the second processor share at least a portion of data in the memory, a format converter coupled to the memory and a format converter cache coupled to the format converter. In one arrangement, the first processor can request the data from a predetermined range of shared addresses in the memory. In addition, the format converter cache can fetch and store the requested data, and the format converter can retrieve the data from the format converter cache. The format converter can translate—based on predetermined rules—the data from a first format to a second format that is native to the first processor. The system can also include suitable software and/or circuitry to carry out the processes described above.

The present invention also concerns a machine readable storage having stored thereon a computer program having a plurality of code sections executable by a portable computing device having a multi-core architecture and at least one shared memory. The code sections can cause the portable computing device to perform the steps of requesting data in a first format from a predetermined range of addresses in the shared memory in which the data is shared between different processors and storing the data in a cache. The code sections can also cause the portable computing device to perform the steps of identifying to a format converter a data type for the data and—with the format converter, retrieving the data from the cache and translating—based on predetermined rules—the data to a second format that is native to a processor that will process the data. The code sections can also cause the portable computing device to perform the steps described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a multi-core architecture in accordance with an embodiment of the inventive arrangements;

FIG. 2 illustrates an example of a block diagram of a system that can exchange data in accordance with an embodiment of the inventive arrangements;

FIG. 3 illustrates a method for exchanging data in accordance with an embodiment of the inventive arrangements;

FIG. 4 illustrates a portion of the system of FIG. 2 and the result of a data translation in accordance with an embodiment of the inventive arrangements;

FIG. 5 illustrates the portion of the system of FIG. 4 and the result of another data translation in accordance with an embodiment of the inventive arrangements;

FIG. 6 illustrates the portion of the system of FIG. 4 and the result of another data translation in accordance with an embodiment of the inventive arrangements;

FIG. 7 illustrates the portion of the system of FIG. 4 and the result of yet another data translation in accordance with an embodiment of the inventive arrangements; and

FIG. 8 illustrates another method for exchanging data in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method and system for exchanging data. In one arrangement, the method can be practiced in a multi-core architecture having at least one shared memory. The method can include the steps of requesting data in a first format from a predetermined range of addresses in the shared memory in which the data is shared between different processors and storing the translated data in a cache to be retrieved by the processor. The method can further include identifying to a format converter a data type for the data and translating—based on predetermined rules—the data to a second format that is native to a processor that will process the data. The translation can be performed with a format converter, which can be programmed with the predetermined rules. The format converter can be programmed with any suitable type of rules to convert data from the first format to the second format, and this process can be used to seamlessly exchange data between processors.

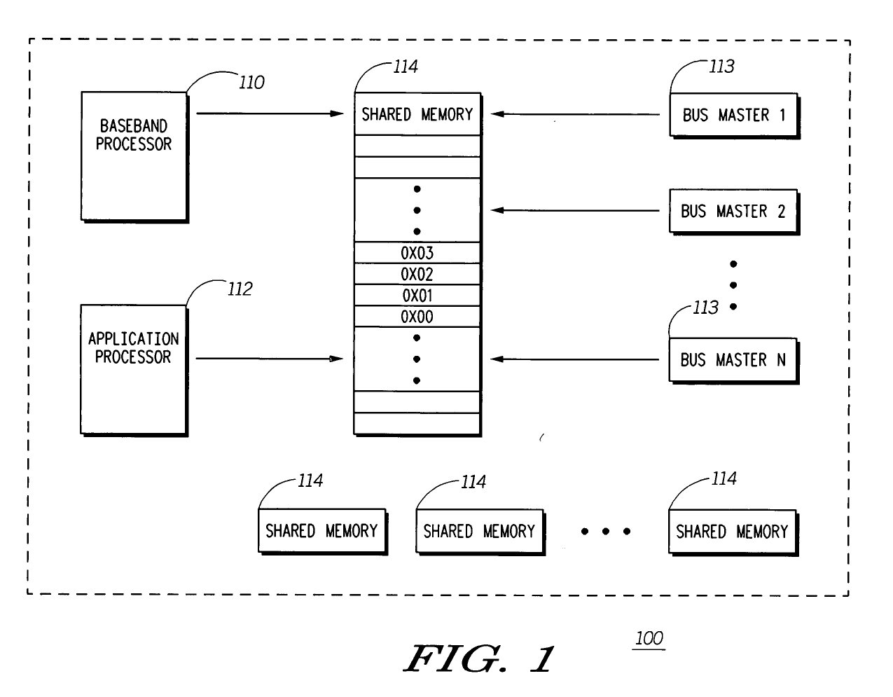

Referring to FIG. 1, a system 100 for exchanging data is shown. The system 100 can include a first processor 110, such as a baseband processor (BP), and a second processor 112, which may be an application processor (AP). Although the first processor 110 may be referred to as a BP and the second processor 112 may be referred to as an AP, the first processor 110 and the second processor 112 may be any suitable type of processor. The system 100 may also include one or more bus masters 113, such as bus masters 1 through N. The BP 110, the AP 112 and the bus masters 113 may share at least a portion of data in a shared memory 114. Although they share data, the BP 110, the AP 112 and the bus master 113 may process the data in their native mode of operation. As shown, the system 100 may include any suitable number of shared memories 114.

As an example, the AP 112 may process the shared data based on a little endian memory model (LE), and the BP 110 may process the shared data on a memory model referred to as emulated big endian (BE-32). As is known in the art, BE-32, which may also be referred to as a word-invariant or munged address endianness mode, is different from the “true” big endian memory model (BE) in that low-order address bits are selectively flipped for certain data sizes, like bytes and words. As an example, the data stored in the shared memory may be in a little endian format. As will be explained below, the system 100 can permit the BP 110 to process the data in its native mode of operation, such as the BE-32 scheme. The bus masters 113 may also process information in accordance with a little endian configuration.

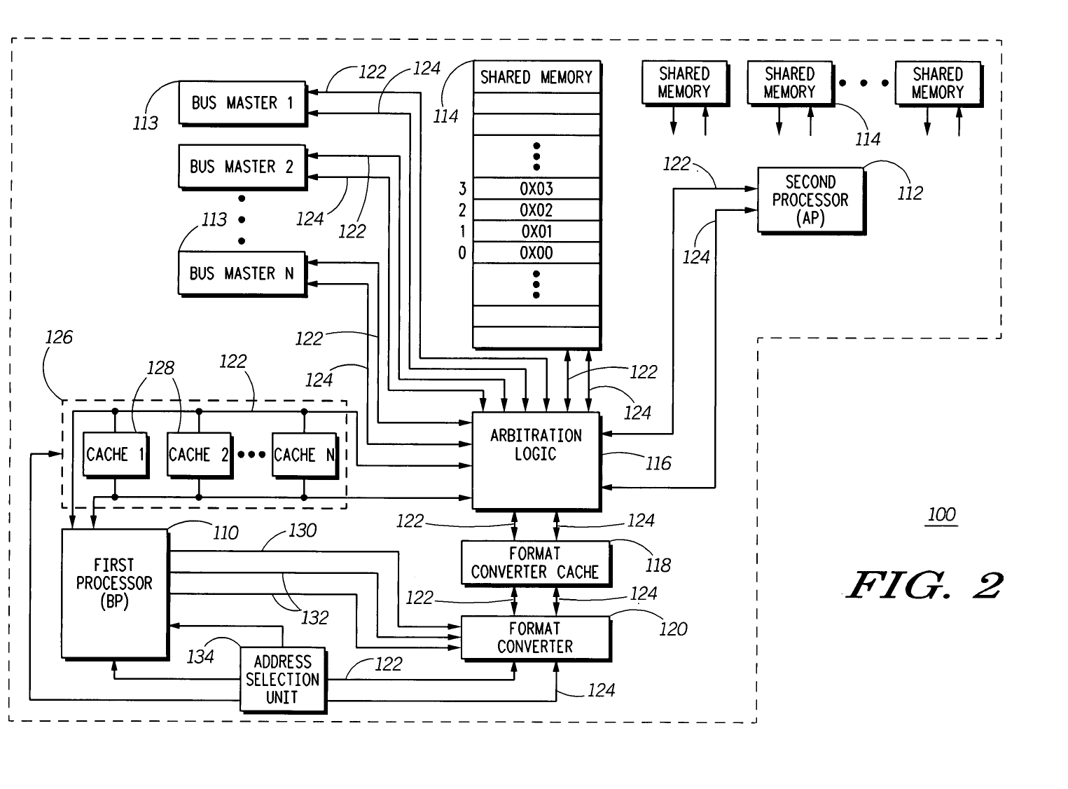

Referring to FIG. 2, a more detailed illustration of the system 100 is shown. In this example, the system 100 can also include arbitration logic 116, a format converter cache 118 and a format converter 120. Data buses 122 and address buses 124 can couple the arbitration logic 116 to the BP 110, the AP 112, the bus masters 113, the shared memory 114 and a format converter cache 118. As an example, the arbitration logic 116 can route signals over the data buses 122 and the address buses 124 between any of the following components: the BP 110, the AP 112, the bus masters 113 and the format converter cache 118. As will be explained below, the format converter cache 118 can store data from any number of shared memories 114, and the format converter 120 can translate this data from a first format to a second format to permit the data to be processed by the BP 110.

In one particular example, the system 100 can include a bypass section 126, which can couple the BP 110 to the arbitration logic 116. This bypass section 126 can contain one or more caches 128, such as instruction or data caches. As an example, these caches 128 can be used to fetch data from the shared memory 114 when the data is in a format that is native to the BP 110. The system 100 can further include a bypass line 130 and data access type lines 132. The BP 110 can enable or disable the format converter 120 through the bypass line 130 and can identify data access types over the data access type lines 132. Although two data access type lines 132 are shown, the system 100 can include any suitable number of these lines 132 for purposes of identifying virtually any type of access type. A data bus 122 and an address bus 124 can also couple the BP processor 110 to the format converter 120 through an address selection unit 134. The BP 110 can request data from addresses in the shared memory 114 through the address selection unit 134.

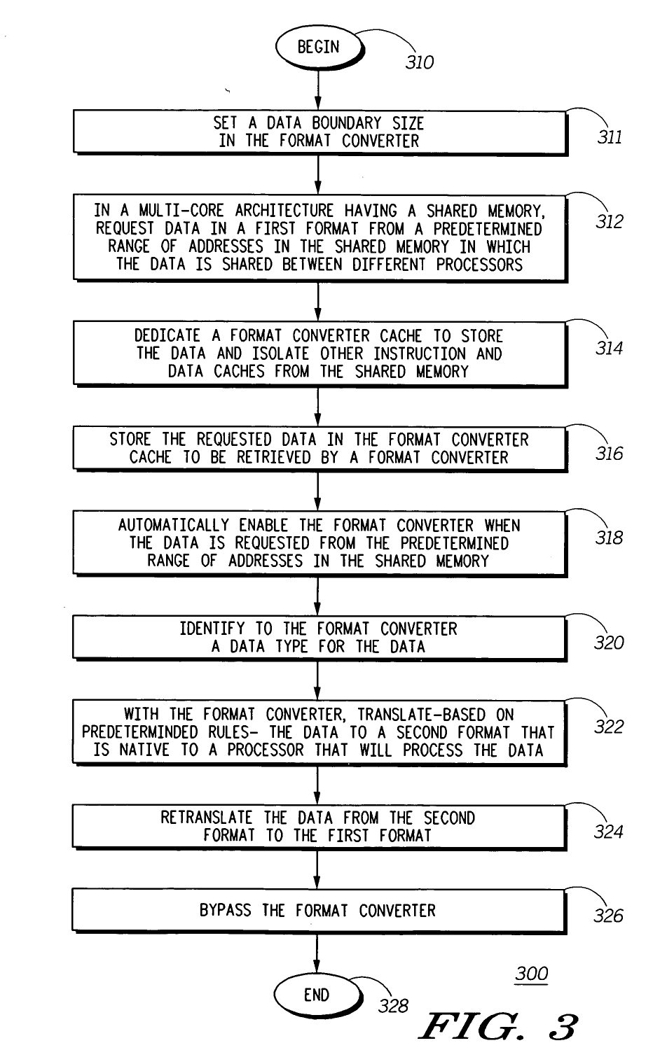

Referring to FIG. 3, a method 300 for exchanging data is illustrated. To describe the method 300, reference may be made to FIG. 2, although the method 300 can be practiced using any other suitable devices or systems. That is, a system for exchanging data in accordance with the inventive arrangements is not limited to that pictured in FIG. 2. Moreover, the method 300 is not limited to the particular steps that are shown in FIG. 3 or to the order in which they are depicted. The inventive method 300 may also include a fewer or greater number of steps as compared to what is shown in FIG. 3.

At step 310, the method 300 can begin. At step 311, a data boundary size of a format converter can be set. At step 312, in a multi-core architecture having at least one shared memory, data in a first format can be requested from a range of predetermined addresses in the shared memory in which the data is shared between different processors. At step 314, a format converter cache can be dedicated to store the data, and other instruction and data caches can be isolated from the shared memory. The requested data can then be stored in the format converter cache, where it can be retrieved by the format converter, as shown at step 316. At step 318, the format converter can be automatically enabled when the data is requested from the predetermined range of addresses in the shared memory.

For example, referring to FIG. 2, the system 100 can be a multi-core architecture having at least one shared memory 114, meaning that it can include at least two processors on a single platform in which the processors read data from and/or write data to at least one common memory. For example, the BP 110 and the AP 112 can read data from and/or write data to the shared memory 114. As a result, the BP 110 and the AP 112 can share data from a shared memory 114.

The data boundary size of the format converter 120 can be set, and in one arrangement, the data boundary size of the format converter 120 can be configured based on a particular bus size. For example, the size of the data bus 122 from the address selection unit 134 and the BP 110 can be thirty-two bits, and the maximum size of the data boundary for the format converter may be 256 bits. If the format converter 120 is to receive data from or pass data to this particular data bus 122, the data boundary size of the format converter 120 can be set to thirty-two bits. Of course, the format converter 120 may be coupled to other data and program buses of various sizes, and its data boundary size can be set based on the bus it will be receiving data from or transferring data to.

To describe one way how the invention operates, an example will be given where the BP 110 requests data from the shared memory in which the BP 110 conforms to a word invariant memory model, such as BE-32, and the AP 112 organizes data based on LE. Of course, the invention is applicable to any system having multiple processors that share data in any other suitable format.

Continuing with the example, the BP 110 can request data from certain addresses, and in response, the address selection unit 134 can determine whether the requested data is stored in a range of predetermined addresses in the shared memory 114. That is, the address selection unit 134 can be programmed with a range of addresses in the shared memory 114, where these addresses contain data that may be shared by the BP 110 and the AP 112. If the requested data is within the range of predetermined addresses, the address selection unit 134 can signal the format converter cache 118 to fetch from the shared memory 114 one or more lines of data having the requested data and to store the lines of data. In this way, the format converter cache 118 has been dedicated to storing the requested data. As will be described later, the format converter 120 can retrieve the requested data from the format converter cache 118.

Additionally, the address selection unit 134 can disable the bypass section 126 by isolating the instruction and data caches 128 from the shared memory 114. The address selection unit 134 can also automatically enable the format converter 120 when the requested data is in the predetermined range of addresses in the shared memory 114. This step can be in anticipation of the format converter 120 translating the requested data from a first format to a second format, as will be explained below.

Referring back to the method 300, at step 320, a data type for the requested data can be identified to the format converter. At step 322, with the format converter, the data—based on predetermined rules—can be translated to a second format that is native to a processor that will process the data.

For example, referring once again to FIG. 2, the BP 110 can signal the format converter 120 over the data access type lines 132 the data type for the data being requested. In one arrangement, the data type can be a byte, a word or a double-word, although any other suitable data type is within contemplation of the inventive arrangements. The data type, as will be illustrated below, can be used to set translation rules for the format converter 120.

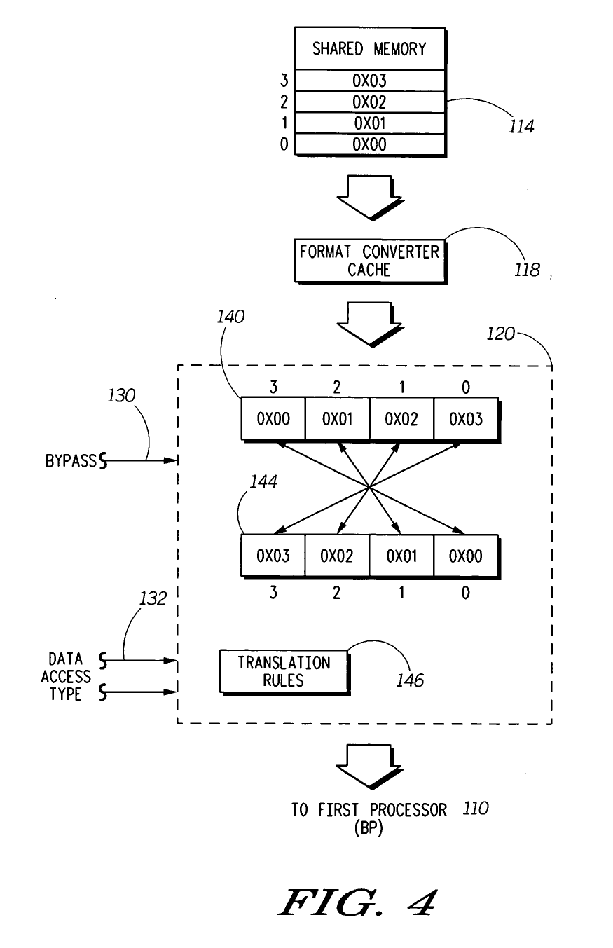

Once it receives the data type, the format converter 120 can retrieve the appropriate data from the format converter cache 118. Referring to FIG. 4, the shared memory 114 (with several addresses listed) and a more detailed view of the format converter 120 are illustrated. In the following examples, it is assumed that the BP processor 110 will perform a four-byte read, although certainly other processor operations are within the scope of the invention.

The format converter 120 can transfer the data from the format converter cache 118 to a first register 140. The first register 140 shows the data as how it appears based on a conventional word-invariant memory model, i.e., no translation has occurred. The numbers below the first register 140 represent address values. In one arrangement, the format converter 120 can be programmed with a set of transition rules 146. These transition rules 146 can instruct the format converter 120 as to how the data will be converted to a second format.

For example, the first format can be LE, and the second format can be a translated word invariant model, such as BE-32. In addition, the data type can be a byte. As is known in the art, BE-32 may sometimes alter the last two address bits of data accessed from a shared memory, depending on the data access type. In particular, for a byte access, the last two address bits can be inverted. Thus, if no translation will occur for this type of data access, the data shown in the shared memory 114, which can be stored in a LE format, may be stored in accordance with the order shown in the first register 140. For instance, the data stored in the shared memory 114 in LE format at address 0 would be stored in the first register 140 at address 3. Such a process may complicate the sharing of the data.

In accordance with an embodiment of the inventive arrangements, the data in the first format can be translated into a second format, which can be native to a processor that will process the data. For example, staying with FIG. 4, the format converter 120 can translate the data based on the set of translation rules 146 from a first format to a second format and can transfer it to a second register 144. Again, the numbers below the second register 144 represent values for addresses. As shown, the data stored at addresses 0 and 1 in the first register 140 can be respectively stored at addresses 3 and 2 in the second register 144. Similarly, the data stored at addresses 2 and 3 in the first register 140 can be stored at addresses 1 and 0 in the second register 144.

Once transferred to the second register 144, the BP 110 can access the data and perform any subsequent operations. Through the translation of the data, the data can be in a format that is native to the BP 110, which improves the efficiency of data sharing.

The translation rules 146, which can be programmed into the format converter 120, can be any suitable program that can translate data from a first format to any format that is native to a processor that requests the data. For example and without limitation, the first format can be selected from LE, BE-32 and true BE memory models, and the second format can be selected from translated LE, translated BE-32 and translated true BE memory models. The translation that occurs can also be dependent on the data access type, as referenced above.

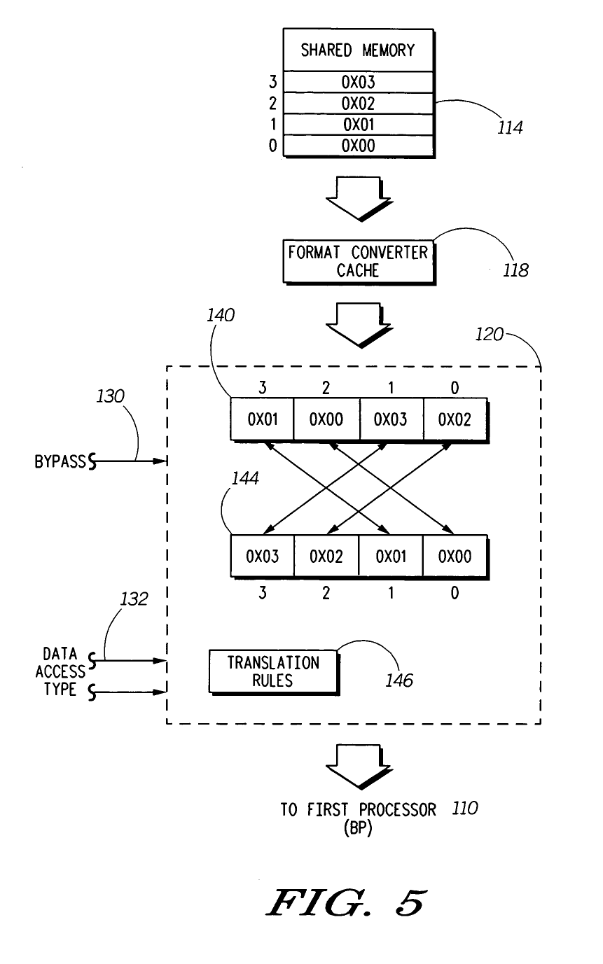

For instance, consider the previous example above, but the data access type can be a word. Referring to FIG. 5, the untranslated data, which complicates data sharing, is shown in the first register 140. Here, the word-invariant format, as is known in the art, inverts the next-to-last address bit when the data access type is a word. The format converter 120, however, can translate the data in the first register 140 to the order shown in the second register 144. This format can be native to the BP 110.

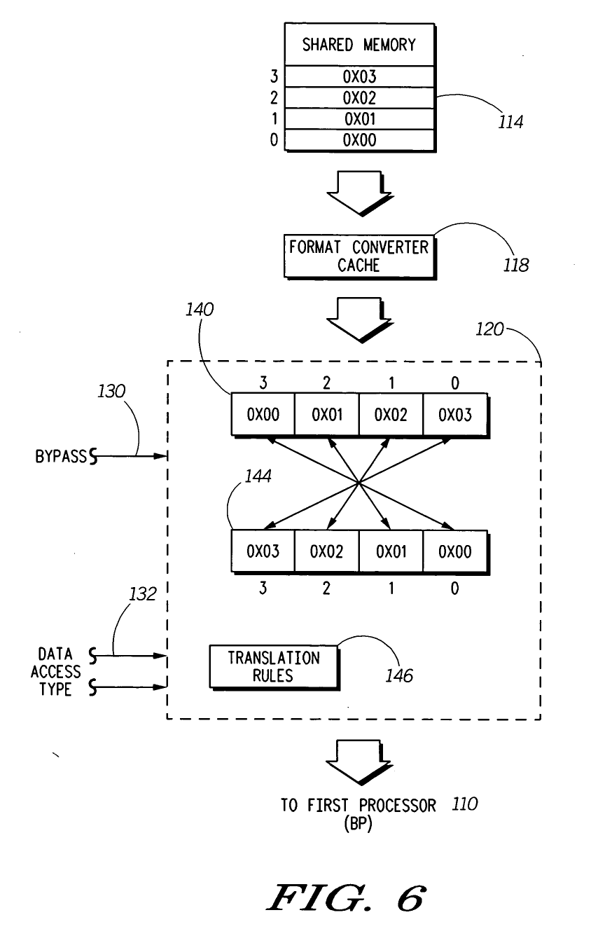

Although the examples above describe the process of translating data from LE to BE-32, it must be understood that the format converter 120 can translate data between virtually any format. As another example and referring to FIG. 6, the first format can be based on a LE scheme, and the second format can be based on a true BE memory model. In this example, the data access type can be a double-word or thirty-two bit. Again, the first register 140 shows the order of the data if no translation operation is performed, which is not optimal. Because it is capable of handling virtually any type of translation, the format converter 120 can convert the data to a second format that is suitable for a processor that employs a true BE scheme. The results are shown in the second register 144. As can be seen, the format converter 120 can be programmed with translation rules that can permit it to translate data from one format to any other format.

Referring back to the method 300 of FIG. 3, at step 324, the data can be retranslated from the second format to the first format. In addition, the format converter can be bypassed if it is unnecessary to translate the data from the first format to the second format, as shown at step 326. Finally, at step 328, the method 300 can end.

For example, referring to FIGS. 2-6, the BP 110 may need to write data back into the shared memory 114. For optimal performance, it is desirable to have the shared data written back in the shared memory 114 in accordance with the memory model in which the shared memory 114 is configured. As a more specific example, the BP 110 may need to write the data that is native to the BP 110 but which conflicts with the memory model employed by the shared memory 114. In response, the address selection unit 134 can signal the format converter 120, which can then retranslate the data back to an order that complies with the memory model of the shared memory 114.

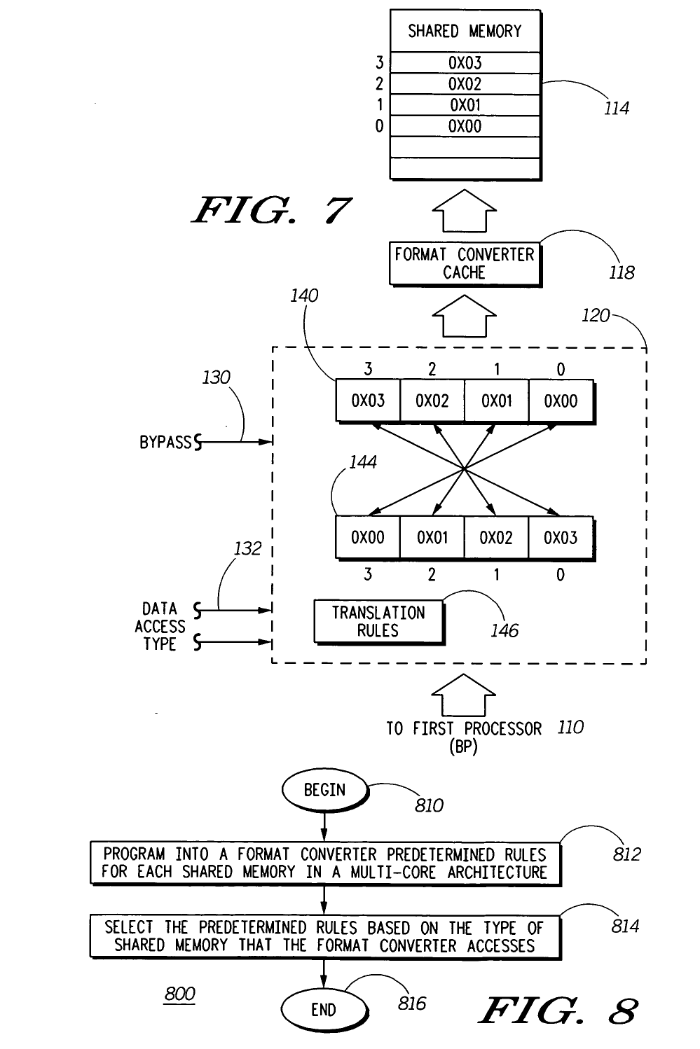

An example of this process is shown in FIG. 7, where the second register 144 shows the translated data received from the BP 110 and the first register 140 depicts the data after it has been retranslated. This particular retranslation can be based on a byte write-back operation. The retranslation can place the data in an order that complies with LE, which can be the memory model for the shared memory 114. It is important to note, however, that the data that is retranslated is not necessarily limited to data that was initially fetched from the shared memory 114. That is, the process of retranslation may apply to any suitable type of data that must be converted to be stored in the shared memory 114.

There may be circumstances where it is desirable to not translate data. In such circumstances, the format converter 120 can be bypassed. For example, the BP 110 may request data that is not within the predetermined range of addresses in the shared memory 114, which means that translation may not be necessary. In response, the address selection unit 134 can disable the format converter 120 and can enable the bypass section 126. Once the bypass section 126 is enabled, any of the caches 128 may be used to retrieve data from the shared memory 114 or some other memory. Through the bypass line 130, the BP 110 can also disable the format converter 120 if no translation is required. The BP processor 110, however, can still use the format converter cache 118 for storing data in a conventional manner. This procedure may be useful if the requested data will be in a format that is native to the BP 110. Of course, the invention is not limited to the examples, as other circumstances may warrant the bypassing of the format converter 120.

As mentioned earlier, although examples have been presented in which the format converter 120 has translated data from LE to BE-32 and true BE, the invention can be used to translate data between other suitable formats. Moreover, the invention is not limited to thirty-two bit machines, as other any other suitable bit size is within contemplation of the inventive arrangements. In addition, the processors in the multi-core architecture are not limited to having the same bit sizes, and any number of format converters 120 and format converter caches 118 may be present in the multi-core architecture.

Referring to FIG. 8, another method 800 for exchanging data is shown. As noted above, the system 100 may include any suitable number of shared memories. The method 800 shows several steps that may be taken in view if this possible configuration. For example, at step 810, the method 800 can begin, and at step 812, predetermined rules can be programmed into a format converter for each shared memory in a multi-core architecture. In addition, at step 814, the predetermined rules can be selected based on the type of shared memory that the format converter accesses.

For example, referring to FIG. 2, the system 100 may include any suitable number of shared memories 114. These shared memories 114 may operate on various memory models, including LE, BE, BE-32 or some other memory configuration. As such, the format converter 120 can be programmed with translation rules 146 that enable the format converter 120 to translate between the various formats of the shared memories 114 and the processor requesting the data, e.g., the BP 110. The format converter 120 can even perform these multiple translations simultaneously, if so desired. The translation rules 146 that the format converter 120 selects can be based on the type of shared memory 114 that is accessed. In particular, this process can refer to the memory organization employed by the shared memory 114 that is accessed.

It is also understood that this multiple translation can apply to a processor writing data to several different shared memories 114. It is also important to note that the system 100 may include any suitable number of format converters 120 and format converter caches 118, each of which are capable of working in tandem to ensure the proper translation of data from any suitable number of shared memories. That is, the system 100 is in no way limited to merely a single format converter 120 or format cache 118. Referring back to FIG. 8, the method 800 can end at step 816.

The present invention, including the translation of data, can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for exchanging data, comprising the steps of:
in a multi-core architecture having at least one shared memory, requesting data in a first format from a predetermined range of addresses in the shared memory, wherein the data is shared between different processors;
storing the requested data in a cache to be retrieved by a format converter;
identifying to the format converter a data type for the data;
with the format converter, retrieving the data from the cache and translating based on predetermined rules the data to a second format that is native to a processor that will process the data.

2. The method according to claim 1, further comprising the step of automatically enabling the format converter when the data is requested from the predetermined range of addresses in the shared memory.

3. The method according to claim 2, wherein when the format converter is enabled, further comprising the steps of:
dedicating the cache to storing the data; and
isolating other instruction and data caches from the shared memory.

4. The method according to claim 1, further comprising the step of setting a data boundary size in the format converter based on a bus size.

5. The method according to claim 1, wherein the predetermined rules are programmable in the format converter.

6. The method according to claim 1, further comprising the step of bypassing the format converter when it is unnecessary to translate the data from the first format to the second format.

7. The method according to claim 1, wherein the first format is based on at least one of a little endian memory model, a big endian memory model and an emulated big endian memory model and the second format is based on at least one of a translated little endian memory model, a translated big endian memory model and a translated emulated big endian memory model.

8. The method according to claim 1, further comprising the step of retranslating the data from the second format to the first format.

9. The method according to claim 1, wherein the data type is at least one of a byte, a word and a double word.

10. The method according to claim 1, wherein the multi-core architecture has a plurality of shared memories and the method further comprises the steps of:
programming predetermined rules for each shared memory into the format converter; and
selecting the predetermined rules based on the type of shared memory that the format converter accesses.

11. A system for exchanging data, comprising:
a first processor;
a second processor;
at least one memory coupled to both the first processor and the second processor, wherein the first processor and the second processor share at least a portion of data in the memory;
a format converter coupled to the memory; and
a format converter cache coupled to the format converter, wherein the first processor requests the data from a predetermined range of shared addresses in the memory, the format converter cache fetches and stores the requested data and the format converter retrieves the data from the format converter cache and translates based on predetermined rules the data from a first format to a second format that is native to the first processor.

12. The system according to claim 11, further comprising an address selection unit coupled to the first processor, wherein the address selection unit automatically enables the format converter when the first processor requests the data from the range of predetermined addresses in the shared memory.

13. The system according to claim 12, further comprising at least one of an instruction cache and a data cache, wherein when the address selection unit enables the format converter, the address selection unit dedicates the format converter cache to storing the data and isolates the instruction cache and the data cache.

14. The system according to claim 11, wherein the first processor identifies to the format converter a data type for the data.

15. The system according to claim 11, wherein the format converter has a data boundary size and the data boundary size is based on a bus size.

16. The system according to claim 11, wherein the predetermined rules are programmable.

17. The system according to claim 11, wherein at least one of the first processor and the address selection unit causes the data to bypass the format converter when it is unnecessary to translate the data from the first format to the second format.

18. The system according to claim 11, wherein the first format is based on at least one of a little endian memory model, a big endian memory model and an emulated big endian memory model and the second format is based on at least one of a translated little endian memory model, a translated big endian memory model and a translated emulated big endian memory model.

19. The system according to claim 11, wherein the format converter retranslates the data from the second format to the first format.

20. The system according to claim 11, wherein the data type is at least one of a byte, a word and a double word.

21. The system according to claim 11, further comprising a plurality of memories, wherein the format converter is programmed with predetermined rules for each memory and the format converter selects the predetermined rules based on the type of memory that the format converter accesses.

22. A machine readable storage, having stored thereon a computer program having a plurality of code sections executable by a portable computing device having a multi-core architecture and at least one shared memory for causing the portable computing device to perform the steps of:
requesting data in a first format from a predetermined range of addresses in the shared memory, wherein the data is shared between different processors;
storing the data in a cache;
identifying to a format converter a data type for the data;
with the format converter, retrieving the data from the cache and translating based on predetermined rules the data to a second format that is native to a processor that will process the data.

23. The machine readable storage according to claim 22, wherein the predetermined rules are programmable in the format converter.
